(19) United States
(12) Patent Application Publication
(10) Pub. No.: US 2006/0229129 A1
(43) Pub. Date: Oct. 12, 2006

(54) System and method for effectuating a push-to-talk service in a multiplayer gaming environment

(75) Inventors: Teemu Jalava, Espoo (FI); Jyri Salomaa, Jorvas (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/100,907

(22) Filed: Apr. 7, 2005

(51) Int. Cl. G06F 19/00; G06F 17/00

(52) U.S. Cl. 463/41

(57) ABSTRACT

A system for effectuating a push-to-talk service in a gaming environment includes a network entity within a gaming architecture, where the network entity is capable of operating an electronic game. The system also includes a client capable of interacting with the network entity in the gaming architecture to play an electronic game. The client is also capable of establishing a push-to-talk session in a multimedia service architecture. The push-to-talk session has at least one associated parameter, which the client can transfer one or more of the parameters to the network entity. Accordingly, the network entity is capable of advertising the parameters to at least one other client to thereby enable the other clients to join the push-to-talk session based upon the parameters.

### FIELD OF THE INVENTION

The present invention generally relates to systems and methods of operating a multiplayer game and, more particularly, relates to systems and methods of effectuating a push-to-talk service in a game operated by a plurality of clients.

### BACKGROUND OF THE INVENTION

Electronic games have become a widespread entertainment feature and are well known in the state of the art as video games or gaming machines. To increase the fun of the game many video games offer the option to play against a computer or against other persons. Some games can be played in a one, two or more player mode, to provide virtual adventures, or to economize expensive gaming equipment. There are actually many different gaming simulations such as sports games, car races, strategy games and even war games available. The attraction of some of these games resides in the fact that the games can be played via networks such as the Internet, enabling remote users to access and play different games with or against other real and/or virtual players, while being in different rooms, homes, towns, countries or even continents.

Typically, electronic games are implemented using application-level gaming infrastructure providing, for example, login, gamer identity, game session or user searches, match-making services or the like. In this regard, by implementing such games using application-level gaming infrastructure, the games are adapted to operate on top of TCP/IP or other protocols as well as alongside other non-gaming applications, thereby ensuring that no need exists for dedicated gaming networks.

During play of electronic games, as in a number of other computing contexts, users desire to communicate with one another. Desktop computers, game consoles, workstations and other wireline computers that provide gaming applications currently allow users to communicate via e-mail, video conferencing, instant messaging (IM) and voice-over-IP (VoIP) to name a few communication applications. Mobile devices, such as mobile telephones, handheld computers, personal digital assistants (PDAs) and the like, which are increasingly also providing gaming applications, also assist in day-to-day communication. Mobile/wireless telephones have conventionally served as voice communication devices, but through technological advancements have recently proved to be effective devices for communicating data, graphics, etc. Wireless and landline technologies continue to merge into a more unified communication system, as user demand for seamless communications across different platforms increases.

Although a number of communication services are currently implemented in the game environment, it is typically desirable to improve upon existing technologies. In this regard, as a number of the current communication systems are proprietary, it would be desirable to design a communication system that draws from existing infrastructures, particularly in the context of mobile devices that are already limited in their computing power, storage space and bandwidth.

### SUMMARY OF THE INVENTION

In light of the foregoing background, embodiments of the present invention provide an improved system and method for effectuating a push-to-talk service, such as a push-to-talk over cellular (PoC) service, in a multiplayer gaming environment. Embodiments of the present invention provide a means for a client, operating in a gaming architecture, to also operate in a multimedia service architecture to effectuate a push-to-talk session. The push-to-talk session can then be utilized by the gaming architecture to enable other clients operating in the gaming architecture to join the push-to-talk session. Embodiments of the present invention are capable of being implemented in a manner utilizing both a gaming architecture and a multimedia service architecture, without requiring integration of one architecture into the other.

According to one aspect of the present invention, a system is provided for effectuating a push-to-talk service in a gaming environment. The system includes a network entity such as a game server within a gaming architecture, where the network entity is capable of operating an electronic game. The system also includes a client capable of interacting with the network entity in the gaming architecture to play an electronic game. The client is also capable of establishing a push-to-talk session in a multimedia service architecture. For example, the network entity can be capable of requesting that the client establish the push-to-talk session. Then, in response, the client can be capable of establishing the push-to-talk session in response to the request. Irrespective of how the push-to-talk session is established, the push-to-talk session has at least one associated parameter, such as a session address. The client can transfer at least one of the parameters to the network entity. Accordingly, the network entity is capable of advertising the parameters to at least one other client to thereby enable the other clients to join the push-to-talk session based upon the parameters.

More particularly, the client can be capable of interacting with the network entity during a game session. In such instances, the network entity can be capable of advertising the parameters to at least one client in the same game session. Additionally or alternatively, the client can be capable of interacting with the network entity to play an electronic game being played by a plurality of teams each having at least one client. Thus, the client can be capable of establishing a plurality of push-to-talk sessions such that each team has an associated push-to-talk session. Then, the network entity can be capable of advertising the parameters of each game session to a respective team.

According to other aspects of the present invention, a network entity, client, method and computer program product are provided for effectuating a push-to-talk service in a gaming architecture. Embodiments of the present invention therefore provide an improved system, network entity, client, method and computer program product are provided for effectuating a push-to-talk service in a gaming architecture. By operating the client within the gaming architecture to play an electronic game, and within a multimedia service architecture to participate in a push-to-talk session, embodiments of the present invention are capable of effectuating a push-to-talk service within a gaming architecture. Also, by effectuating the push-to-talk service via the client, the gaming architecture and the multimedia service architecture need not be integrated with one another, and can accordingly be maintained separate from one another. As such, the system, network entity, client, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of one type of terminal and system that would benefit from embodiments of the present invention;

FIG. 2 is a schematic block diagram of an entity capable of operating as a mobile station, game server, routing server, personal computer (PC) system, game console and/or PoC server, in accordance with embodiments of the present invention;

FIG. 3 is a schematic block diagram more particularly illustrating a mobile station in accordance with one embodiment of the present invention;

FIG. 4 is a schematic block diagram of various network entities of the system of FIG. 1 configured in a multiplayer gaming architecture, in accordance with one embodiment of the present invention;

FIG. 5 is a schematic block diagram of a multi-layer protocol stack of a client operating in a multiplayer gaming architecture, in accordance with one embodiment of the present invention;

FIG. 6 is a schematic block diagram of various network entities of the system of FIG. 1 configured in an IP multimedia subsystem (IMS) architecture, in accordance with one embodiment of the present invention;

FIG. 7 is a schematic block diagram of a multi-layer protocol stack of a client operating in an IMS architecture, in accordance with one embodiment of the present invention;

FIG. 8 is a schematic block diagram of various network entities of a client operating in both a gaming architecture and an IMS architecture, in accordance with one embodiment of the present invention;

FIG. 9 is a schematic block diagram of a multi-layer protocol stack of a client operating in both a gaming architecture and an IMS architecture, in accordance with one embodiment of the present invention; and

FIG. 10 is a flowchart including various steps in a method of effectuating a PoC service in a multiplayer gaming environment, in accordance with one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

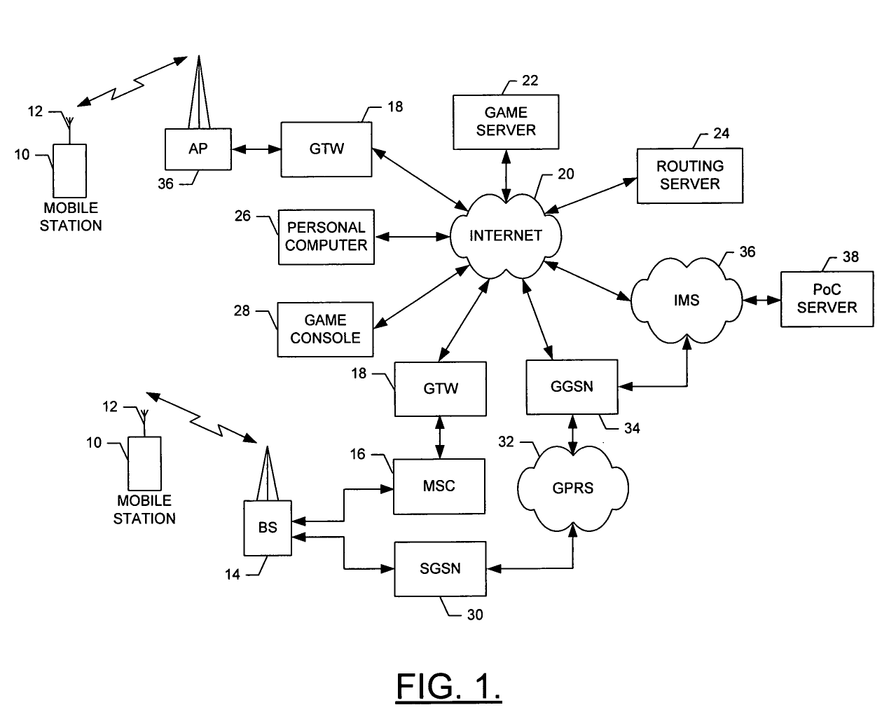

Referring to FIG. 1, an illustration of one type of system that would benefit from the present invention is provided. The system, method and computer program product of embodiments of the present invention will be primarily described in conjunction with mobile communications applications. It should be understood, however, that the system, method and computer program product of embodiments of the present invention can be utilized in conjunction with a variety of other applications, both in the mobile communications industries and outside of the mobile communications industries. For example, the system, method and computer program product of embodiments of the present invention can be utilized in conjunction with wireline and/or wireless network (e.g., Internet) applications.

The system can include one or more mobile stations 10, each having an antenna 12 for transmitting signals to and for receiving signals from one or more base stations (BS's) 14, one of each being shown in FIG. 1. The base station is a part of one or more cellular or mobile networks that each includes elements required to operate the network, such as one or more mobile switching centers (MSC) 16. As well known to those skilled in the art, the mobile network may also be referred to as a Base Station/MSC/Interworking function (BMI). In operation, the MSC is capable of routing calls, data or the like to and from mobile stations when those mobile stations are making and receiving calls, data or the like. The MSC can also provide a connection to landline trunks when mobile stations are involved in a call.

The MSC 16 can be coupled to a data network, such as a local area network (LAN), a metropolitan area network (MAN), and/or a wide area network (WAN). The MSC can be directly coupled to the data network. In one typical embodiment, however, the MSC is coupled to a Gateway (GTW) 18, and the GTW is coupled to a WAN, such as the Internet 20. In turn, devices such as processing elements (e.g., personal computers, server computers or the like) can be coupled to the mobile station 10 via the Internet. For example, as explained below, the processing elements can include one or more processing elements associated with one or more game servers 22, routing servers 24, personal computer (PC) systems 26, game consoles 28, or the like, one of each being illustrated in FIG. 1 and described below. As will be appreciated, the processing elements can comprise any of a number of processing devices, systems or the like capable of operating in accordance with embodiments of the present invention.

The BS 14 can also be coupled to a Serving GPRS (General Packet Radio Service) Support Node (SGSN) 30. As known to those skilled in the art, the SGSN is typically capable of performing functions similar to the MSC 16 for packet switched services. The SGSN, like the MSC, can be coupled to a data network, such as the Internet 20. The SGSN can be directly coupled to the data network. In a more typical embodiment, however, the SGSN is coupled to a packet-switched core network, such as a GPRS core network 32. The packet-switched core network is then coupled to another GTW, such as a GTW GPRS support node (GGSN) 34, and the GGSN is coupled to the Internet.

The GGSN 30 and Internet 20 can be coupled to a IP multimedia subsystem (IMS) 36 that includes various entities for the provision of multimedia services, such as in a manner defined by the third generation partnership project (3GPP). As explained in greater detail below, the IMS can be coupled to an application server for providing the push-to-talk over cellular (PoC) service, also known as PTT, push-to-talk service or the like. Thus, as shown, the application server providing the PoC service is referred to as a PoC server 38.

Although not every element of every possible network is shown and described herein, it should be appreciated that the mobile station 10 may be coupled to one or more of any of a number of different networks. In this regard, mobile network(s) can be capable of supporting communication in accordance with any one or more of a number of first-generation (1G), second-generation (2G), 2.5G and/or third-generation (3G) mobile communication protocols or the like. More particularly, one or more mobile stations may be coupled to one or more networks capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. In addition, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

One or more mobile stations 10 (as well as one or more processing elements, although not shown as such in FIG. 1) can further be coupled to one or more wireless access points (APs) 36. The AP's can be configured to communicate with the mobile station in accordance with techniques such as, for example, radio frequency (RF), Bluetooth (BT), infrared (IrDA) or any of a number of different wireless networking techniques, including WLAN techniques. The APs may be coupled to the Internet 20. Like with the MSC 14, the AP's can be directly coupled to the Internet. In one embodiment, however, the APs are indirectly coupled to the Internet via a GTW 18. As will be appreciated, by directly or indirectly connecting the mobile stations and the user processors (e.g., game servers 22, routing servers 24, personal computer (PC) systems 26, game consoles 28, PoC servers 38, etc.) and/or any of a number of other devices to the Internet, whether via the AP's or the mobile network(s), the mobile stations and user processors can communicate with one another to thereby carry out various functions of the respective entities, such as to transmit and/or receive data, content or the like. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of the present invention.

Although not shown in FIG. 1, in addition to or in lieu of coupling the mobile stations 10 to game servers 22, routing servers 24, personal computer (PC) systems 26 and/or game consoles 28 across the Internet 20, one or more such entities may be directly coupled to one another. As such, one or more network entities may communicate with one another in accordance with, for example, RF, BT, IrDA or any of a number of different wireline or wireless communication techniques, including LAN and/or WLAN techniques.

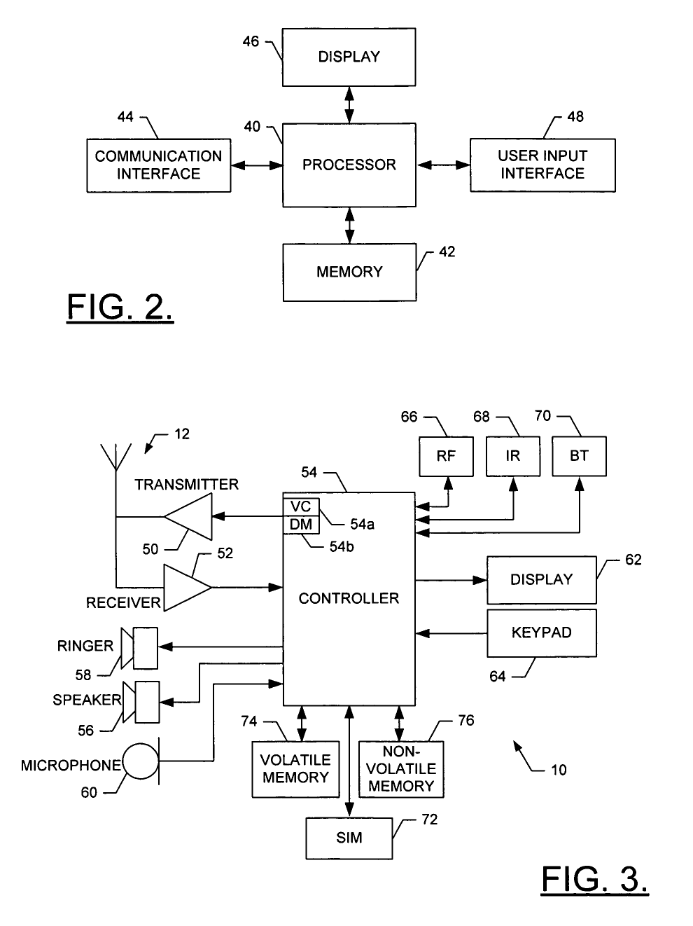

Referring now to FIG. 2, a block diagram of an entity capable of operating as a mobile station 10, game server 22, routing server 24, personal computer (PC) system 26, game console 28 and/or PoC server 38, is shown in accordance with one embodiment of the present invention. Although shown as separate entities, in some embodiments, one or more entities may support one or more of a mobile station, game server, routing server, personal computer (PC) system and/or game console, logically separated but co-located within the entit(ies). For example, a single entity may support a logically separate, but co-located, game server and routing server. Also, for example, a single entity may support a logically separate, but co-located personal computer and game console. Additionally or alternatively, a single entity may support a logically separate, but co-located game server and one or more of a mobile station, PC system and/or game console.

As shown, the entity capable of operating as a mobile station 10, game server 22, routing server 24, personal computer (PC) system 26, game console 28 and/or PoC server 38 generally includes a processor 40 connected to a memory 42. The memory can comprise volatile and/or non-volatile memory, and typically stores content, data or the like. For example, the memory typically stores content transmitted from, and/or received by, the entity. Also for example, the memory typically stores client applications, instructions or the like for the processor to perform steps associated with operation of the entity in accordance with embodiments of the present invention. As explained below, for example, the memory can store client application(s) including a configuration utility, content manager and/or display manager. In this regard, when executed, the configuration utility may function to configure a source of content to receive or otherwise provide content. The content manager, when executed, may function to manage the receipt of content from the source, and/or the use of content received from the source. And the display manager may function to manage presentation of content received from the source. As described herein, the client application(s) each comprise software operated by the respective entities. It should be understood, however, that any one or more of the client applications described herein can alternatively comprise firmware or hardware, without departing from the spirit and scope of the present invention.

In addition to the memory 42, the processor 40 can also be connected to at least one interface or other means for displaying, transmitting and/or receiving data, content or the like. In this regard, the interface(s) can include at least one communication interface 44 or other means for transmitting and/or receiving data, content or the like, as well as at least one user interface that can include a display 46 and/or a user input interface 48. The user input interface, in turn, can comprise any of a number of devices allowing the entity to receive data from a user, such as a keypad, a touch display, a joystick or other input device.

Reference is now made to FIG. 3, which illustrate one type of mobile station 10, a mobile telephone, which would benefit from embodiments of the present invention. It should be understood, however, that the mobile station illustrated and hereinafter described is merely illustrative of one type of mobile station that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers, mobile gaming devices and other types of electronic systems, can readily employ the present invention.

As shown, in addition to an antenna 12, the mobile station 10 can include a transmitter 50, receiver 52, and controller 54 or other processor that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of first generation (1G), second generation (2G), 2.5G and/or third-generation (3G) communication protocols or the like. For example, the mobile station may be capable of operating in accordance with 2G wireless communication protocols IS-136 (TDMA), GSM, and IS-95 (CDMA). Also, for example, the mobile station may be capable of operating in accordance with 2.5G wireless communication protocols GPRS, EDGE, or the like. Further, for example, the mobile station may be capable of operating in accordance with 3G wireless communication protocols such as UMTS network employing WCDMA radio access technology. Some NAMPS, as well as TACS, mobile stations may also benefit from the teaching of this invention, as should dual or higher mode phones (e.g., digital/analog or TDMA/CDMA/analog phones).

It is understood that the controller 54 includes the circuitry required for implementing the audio and logic functions of the mobile station 10. For example, the controller may be comprised of a digital signal processor device, a microprocessor device, and various analog-to-digital converters, digital-to-analog converters, and other support circuits. The control and signal processing functions of the mobile station are allocated between these devices according to their respective capabilities. The controller can additionally include an internal voice coder (VC) 54a, and may include an internal data modem (DM) 54b. Further, the controller may include the functionally to operate one or more client software programs such as those indicated above, which may be stored in memory (described below).

The mobile station 10 also comprises a user interface including a conventional earphone or speaker 56, a ringer 58, a microphone 60, a display 62, and a user input interface, all of which are coupled to the controller 54. Although not shown, the mobile station can include a battery for powering the various circuits that are required to operate the mobile station, as well as optionally providing mechanical vibration as a detectable output. The user input interface, which allows the mobile station to receive data, can comprise any of a number of devices allowing the mobile station to receive data, such as a keypad 54, a touch display (not shown), a joystick (not shown) or other input device. In embodiments including a keypad, the keypad includes the conventional numeric (0-9) and related keys (#, *), and other keys used for operating the mobile station.

The mobile station 10 can also include one or more means for sharing and/or obtaining data. For example, the mobile station can include a short-range radio frequency (RF) transceiver or interrogator 66 so that data can be shared with and/or obtained from electronic devices in accordance with RF techniques. The mobile station can additionally, or alternatively, include other short-range transceivers, such as, for example an infrared (IR) transceiver 68, and/or a Bluetooth (BT) transceiver 70 operating using Bluetooth brand wireless technology developed by the Bluetooth Special Interest Group. The mobile station can therefore additionally or alternatively be capable of transmitting data to and/or receiving data from electronic devices in accordance with such techniques. Although not shown, the mobile station can additionally or alternatively be capable of transmitting and/or receiving data from electronic devices according to a number of different wireless networking techniques, including WLAN techniques such as IEEE 802.11 techniques or the like.

The mobile station 10 can further include memory, such as a subscriber identity module (SIM) 72, a removable user identity module (R-UIM) or the like, which typically stores information elements related to a mobile subscriber. In addition to the SIM, the mobile station can include other removable and/or fixed memory. In this regard, the mobile station can include volatile memory 74, such as volatile Random Access Memory (RAM) including a cache area for the temporary storage of data. The mobile station can also include other non-volatile memory 76, which can be embedded and/or may be removable. The non-volatile memory can additionally or alternatively comprise an EEPROM, flash memory or the like. The memories can store any of a number of software applications, instructions, pieces of information, and data, used by the mobile station to implement the functions of the mobile station.

As will be appreciated, a number of the entities of the system of FIG. 1 can be configured in any of a number of different architectures to perform any of a number of functions, such as to manage a multiplayer game. For example, the entities of the system of FIG. 1 can be configured to manage a multiplayer game in a centralized client-server architecture, decentralized architecture and/or proxy architecture, each of which are explained above in the background section. Additionally or alternatively, for example, the entities of the system of FIG. 1 can be configured in an architecture given in the Scalable Network Application Package (SNAP) (formerly Sega Network Application Package) provided by Nokia Corporation for applications such as in the context of multiplayer gaming.

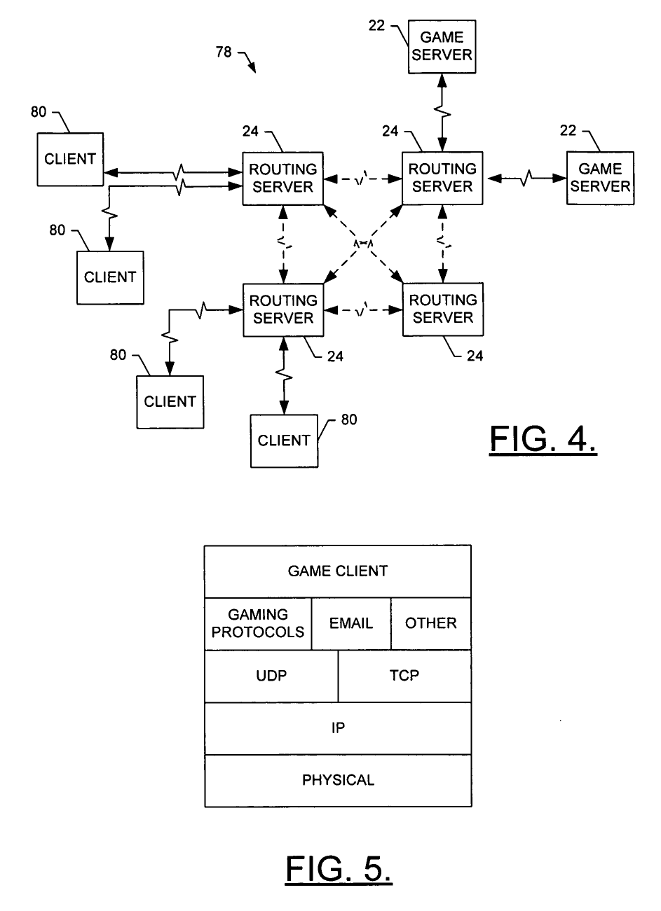

Reference is now made to FIG. 4, which illustrates a multiplayer gaming architecture 78 in accordance with one embodiment of the present invention. As shown, one or more mobile stations 10, PC systems 26 and/or game consoles 28 may operate as clients 80 in the gaming architecture that also includes one or more game servers 22 and/or routing servers 24. In the illustrated architecture, similar to a conventional client-server architecture (see background section above), the game servers operate games and maintain the state of those games. As will be appreciated, however, the routing servers and/or one or more of the clients themselves may alternatively operate portions, or all, of the games and maintain the state of those games. Accordingly, client and/or routing server may also support a game server. As used herein, then, although games can be operated by one or more network entities, including game servers, routing servers and/or client(s), the following description may refer to a game server as operating the games for purposes of illustration. Irrespective of the network entit(ies) that operate the games, however, the clients operate game clients that communicate with those network entit(ies) to continuously change the game state of the games operated and maintained by the network entit(ies) to thereby play those games.

Also in the illustrated architecture 78, the clients 80 are operatively coupled to routing servers 24 which, in turn, are coupled to the game servers 22. Thus, the routing servers route data packets between one or more clients and the game servers, and/or other clients, to facilitate the operation of each entity in the architecture. As shown, the routing servers can be coupled between groups of clients and one or more game servers, directly or indirectly via one or more other routing servers. In this regard, one or more routing servers can also be coupled to other routing servers such that the routing servers can also be coupled between one or more clients and one or more groups of other clients, such as groups of clients coupled to other routing servers.

FIG. 5 illustrates a multi-layer protocol stack of a client 80 operating in a gaming architecture such as that shown in FIG. 4. As shown, a game client in an application layer operates above a session layer to provide synchronization control of data in accordance with one or more different types of data sessions including, for example, a gaming protocol session, email session and the like. The application and session layers, in turn, operate above a transport layer (e.g., transmission control protocol (TCP), user datagram protocol (UDP), or the like) that provides data connection services to applications and may contain mechanisms that guarantee that data is delivered error-free, without omissions and in sequence. The transport layer in the illustrated stack sends segments by passing them to the IP layer, which routes them to the destination. The transport layer accepts incoming segments from the IP layer, determines which application is the recipient, and passes the data to that application in the order in which it was sent.

Thus, the IP layer performs network layer functions and routes data between entities. Data may traverse a single link or may be relayed across several links in an IP network. Data is carried in units called datagrams, which include an IP header that contains data-link layer addressing information. Routers examine the destination address in the IP header in order to direct datagrams to their destinations. The IP layer is called connectionless because every datagram is routed independently and the IP layer does not guarantee reliable or in-sequence delivery of datagrams. The IP layer routes its traffic without caring to which application-to-application interaction a particular datagram belongs.

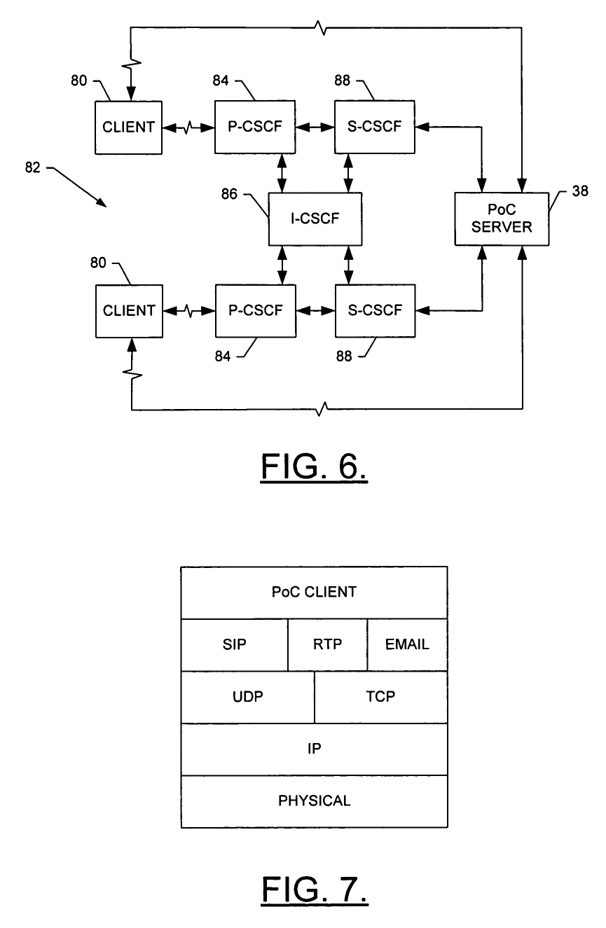

Referring to FIG. 6, an IMS architecture 82 is shown for providing PoC service to a plurality of mobile stations 10, PC systems 26 and/or game consoles 28 operating as clients 80. Within the IMS architecture, the clients may connect to application servers that are generally connected to the IMS architecture. In FIG. 6, such an application server for providing a PoC service is shown as a PoC server 38. To connect the clients to the PoC server, the IMS architecture includes a number of network entities known as servers. As shown, for example, the IMS architecture can include a number of call session (or state) control functions (CSCFs) to handle different functions. The CSCFs may, in turn, be divided into various categories such as a proxy CSCF (P-CSCF) 84, interrogating CSCF (I-CSCF) 86, and serving CSCF (S-CSCF) 88. Briefly, the P-CSCF provides the clients with a gateway or entry point into the IMS architecture. The I-CSCF operates as the authentication contact point within the IMS architecture for connections to clients. The S-CSCF, on the other hand, performs the session control services for the clients, providing the call intelligence and business logic.

The signaling between the clients 80 and the appropriate CSCFs 84, 86, 88 is typically routed via a radio access network, such as the GPRS network or backbone 32. The user plane session set-up signaling for a client is routed via and controlled by the PoC server 38. That is, the PoC server controls both the control plane and the user plane of the client. It shall be appreciated that the control plane traffic between the client and the PoC server is typically routed via the IMS architecture 82, such as in accordance with the Session Initiation Protocol (SIP). The user plane traffic between the client and the PoC server, on the other hand, is typically routed from the radio access (e.g., GPRS) network to the PoC server, such as in accordance with the respective radio access network.

In FIG. 7, the multi-layer protocol stack of a client 80 operating in an IMS architecture 82, such as that shown in FIG. 6, is shown. The client, such as a PoC client, operates in an application layer above a session layer for data sessions such as those in accordance with SIP, real-time transport protocol (RTP) services, email and the like. Like the application and session layers of the client stack in the gaming architecture 78, the application and session layers operate above a transport layer (e.g., transmission control protocol (TCP), user datagram protocol (UDP), or the like). The transport layer in the illustrated stack sends segments by passing them to the IP layer, which routes them to the destination. The transport layer accepts incoming segments from the IP layer, determines which application is the recipient, and passes the data to that application in the order in which it was sent.

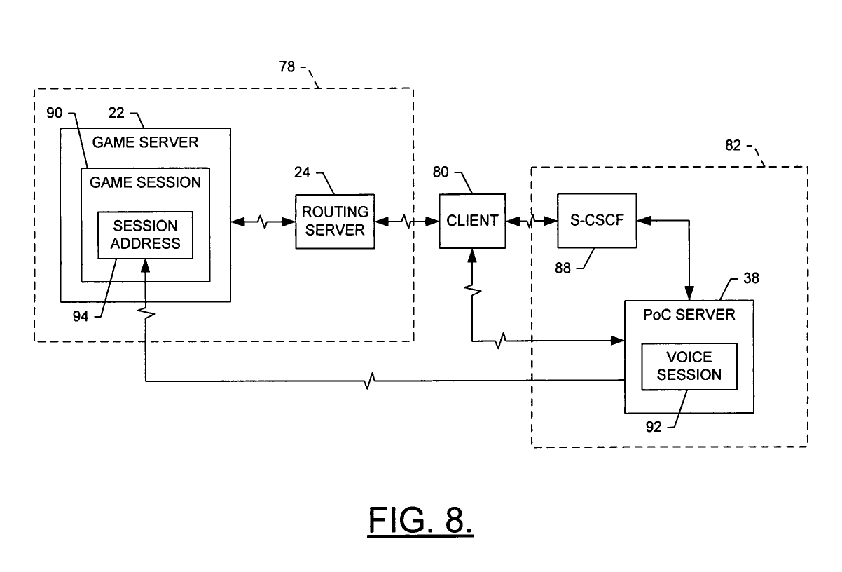

Embodiments of the present invention provide an improved framework for providing a communication service, such as the PoC service within the IMS architecture 78, to a client 80 playing a multiplayer game in a gaming architecture 78. Reference is now drawn to FIGS. 8, 9 and 10, which illustrate functional block diagram, protocol stack and method, respectively, of providing communication service within a multiplayer game environment. As shown in FIG. 8, then, a client 80 operates within a gaming architecture to send data packets to and/or receive data packets from a game server 22 (via one or more routing servers 24) to play a multiplayer game. In this regard, the game server is capable of establishing and maintaining a game session 90 for a plurality of clients, the game server operating the game and maintaining the state of that game based at least in part on data packets received from the clients.

As the client 80 operates in the gaming architecture 78, the client is also capable of operating within an IMS architecture 78 to send data packets to and/or receive data packets from a PoC server 38 (via a S-CSCF 88) to receive a push-to-talk type communication service. In this regard, the PoC server is capable of establishing a PoC session 92 between a plurality of clients, the PoC server passing data packets between the clients such that the clients, or more particularly client users, participate in a PoC session therebetween. Further, to provide the communication service to the client as the client operates in the gaming architecture, the game server 22 is made aware of the IMS architecture and its capabilities, as well as an address 94 associated with a PoC session of the client, as explained below.

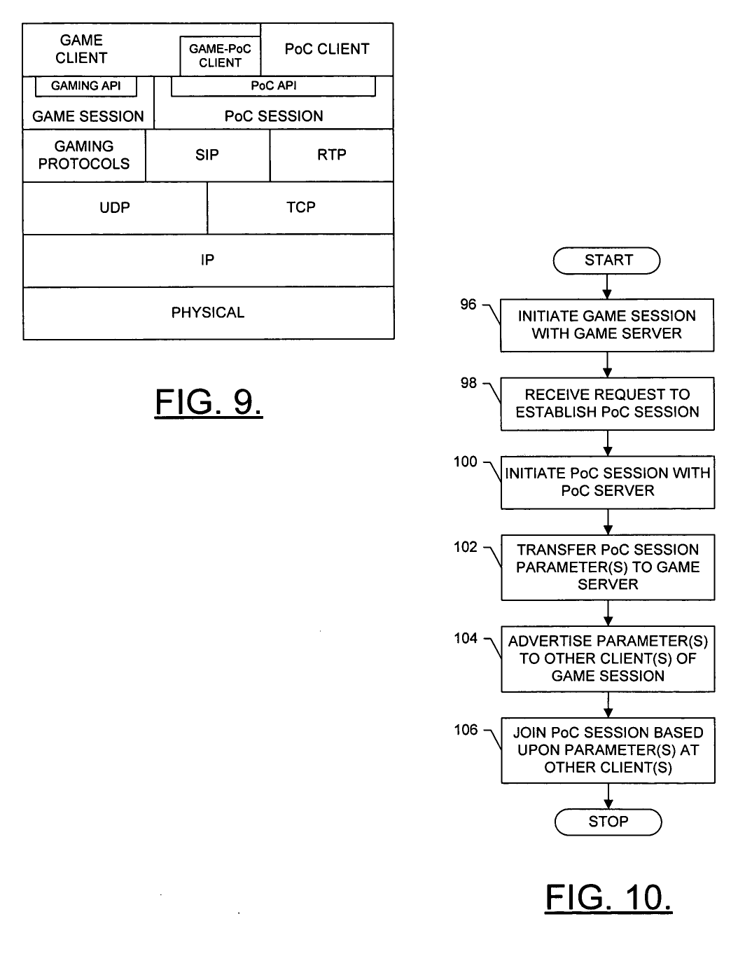

Reference is now made to FIG. 9, which illustrates the protocol stack of a client 80 operating in both the gaming architecture 78 and the IMS architecture 82. As shown, the application layer includes both a game client and a PoC client that each operate above a session layer that includes both a game session and a PoC session. The game client includes a game-PoC module operating on top of the PoC session so that when an existing PoC session is created via the PoC client, the same session can be later controlled by the game client via the game-PoC module without requiring the user to switch between the different clients. In this regard, to effectuate communication between the application layer and the session layer for providing communication service in the multiplayer game environment, the client includes one or more game application programming interfaces (APIs) interfacing between the game client and the game service. Likewise, the client includes one or more PoC APIs interfacing between the game-PoC module and the PoC service, and between the PoC client and the PoC service.

Now with reference to FIG. 10, a method of effectuating a PoC service in a multiplayer gaming environment includes providing a plurality of clients 80 capable of interacting with a game server 22 to thereby play an electronic game. For example, a plurality of clients, or client users, may register with the game server to play an electronic game operated and maintained by the game server, such as by means of game clients operated by the respective clients. Then, to play the electronic game operated and maintained by the game server, a registered client user may operate the game client to log in or otherwise authenticate to the game server to initiate a game session, and thereafter interact with the game server to play the electronic game during the game session, as shown in block 96. The client is accordingly operating in a gaming architecture 78 including the respective game server.

As the clients 80, or more particularly the game clients operated by the clients, interact with the game server 22 during the game session, the game server may send a client a request to establish one or more PoC sessions within an IMS architecture 82, as shown in block 98. Alternatively, before or as a client interacts with the game server, the client may desire to establish one or more PoC sessions within the IMS architecture irrespective of a request from the game server. In response to the request of a self-initiated trigger, the client, or more particularly the game-PoC module, initiates or otherwise establishes one or more PoC sessions with one or more PoC servers 38 within the IMS architecture, as shown in block 100. In this regard, in establishing each PoC session, a number of parameters are established or otherwise determined by which the session may be joined by the client as well as other clients. For example, the PoC server may assign a session address or other identifier that may be transferred to the client for accessing the PoC session. Other parameters may include, for example, an address or other identifier of the PoC server, as well as any other parameters that may define requirements of joining the PoC session. The client is thereby enabled to operate in the IMS architecture.

After the PoC session(s) have been established, the session parameter(s) are transferred to the game server 22 that originally requested the client to establish the PoC session, as shown in block 102. The parameter(s) may more typically be transferred from the client 80 to the game server. It should be understood, however, that one or more of the parameters may alternatively be transferred from the PoC server to the game server. And in yet other instances, one or more of the parameters may already be known to the game server, such as the address of the PoC server effectuating the PoC session. Irrespective of how the parameter(s) are transferred to the game server, however, the game server can thereafter advertise the parameter(s) to other clients playing the multiplayer game, as shown in block 104. For example, the game server may advertise the parameter(s) to other clients of the same game session. Further, within a game session, the game server may advertise the parameter(s) to other clients associated with the client that established the PoC session, such as other clients on a team with the respective client within the game. Alternatively, a client on a team playing a game against another team may receive a request to establish two PoC sessions. After establishing the PoC sessions and transferring parameters for each PoC session to the game server, the game server can advertise one set of parameter(s) to the clients of each team. The members of each team may then join in a respective PoC session.

As the game server 22 advertises the parameter(s) of the PoC session to other clients 80, the other clients receiving the advertised parameter(s) can, if so desired, join the PoC session based upon the respective parameter(s), as shown in block 106. In this regard, the game-PoC modules of one or more other clients can receive the advertised parameter(s) and communicate with the respective PoC server 38 based upon the PoC server address to join a PoC session based upon the PoC session address. Accordingly, while the clients play a multiplayer game within the gaming architecture 78, the clients can simultaneously participate in a PoC service of the PoC server within the IMS architecture 82. As clients may join the game session at one or more instances after the game server initially advertises the parameter(s) of the PoC session, or as one or more clients may otherwise subsequently desire to join the PoC session, the game server may periodically advertise the parameter(s). Additionally or alternatively, the game server may advertise the parameter(s) to new clients joining the game session.

As shown and explained herein, clients 80 participate in a PoC session in an IMS architecture 82 while operating in a gaming architecture. It should be understood, however, that the IMS architecture is only one of a number of different types of architectures via which a push-to-talk session is capable of being effectuated in accordance with embodiments of the present invention. Likewise, PoC is only one of a number of different types of push-to-talk communication services capable of being provided to clients operating in a gaming architecture in accordance with embodiments of the present invention.

According to one aspect of the present invention, all or a portion of the system of the present invention, such all or portions of the game server 22, routing server 24, PoC server 38 and/or client 80 (e.g., mobile station 10, PC system 26, game console 28, etc.), generally operate under control of a computer program product (e.g., game client, game-PoC module, PoC client, etc.). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 10 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for effectuating a push-to-talk service in a gaming environment, the system comprising:
a network entity within a gaming architecture, the network entity being capable of at least partially operating an electronic game; and
a client capable of interacting with the network entity in the gaming architecture to play an electronic game,
wherein the client is capable of establishing a push-to-talk session in a multimedia service architecture, the push-to-talk session having at least one associated parameter,
wherein the network entity is capable of receiving at least one of the parameters, and
wherein the network entity is capable of advertising the received parameters to at least one other client to thereby enable the other clients to join the push-to-talk session based upon the parameters.

2. A system according to claim 1, wherein the network entity is capable of requesting that the client establish the push-to-talk session, and
wherein the client is capable of establishing the push-to-talk session in response to the request.

3. A system according to claim 1, wherein the client is capable of receiving at least one associated parameter during establishment of the push-to-talk session, and
wherein at least one of the parameters comprises a session address.

4. A system according to claim 1, wherein the client is capable of interacting with the network entity during a game session, and
wherein network entity is capable of advertising the received parameters to at least one client in the same game session.

5. A system according to claim 1, wherein the client is capable of interacting with the network entity to play an electronic game being played by a plurality of teams each having at least one client,
wherein the client is capable of establishing a plurality of push-to-talk sessions such that each team has an associated push-to-talk session, and
wherein the network entity is capable of advertising the received parameters of each game session to a respective team.

6. A client for effectuating a push-to-talk service in a gaming environment, the client comprising:
a processor capable of operating a game client, the game client being capable of interacting with a network entity in a gaming architecture to play an electronic game during a game session,
wherein the game client is capable of establishing a push-to-talk session in a multimedia service architecture at least one of before or during play of the electronic game such that the push-to-talk session at least partially overlaps the game session.

7. A client according to claim 6, wherein the game client is further capable of receiving a request from the network entity to establish a push-to-talk session, and
wherein the game client is capable of establishing the push-to-talk session in response to the request.

8. A client according to claim 6, wherein the game client is capable of receiving at least one associated parameter during establishment of the push-to-talk session, and
wherein the game client is capable of transferring at least one of the parameters to the network entity.

9. A client according to claim 8, wherein the game client is capable of receiving at least one associated parameter during establishment of the push-to-talk session, wherein at least one of the parameters comprises a session address.

10. A client according to claim 8, wherein the game client is capable of interacting with the network entity during a game session, and
wherein the game client is capable of transferring at least one of the parameters such that the network entity advertises the transferred parameters to at least one client in the same game session.

11. A client according to claim 8, wherein the game client is capable of interacting with the network entity to play an electronic game being played by a plurality of teams each having at least one client,
wherein the game client is capable of establishing a plurality of push-to-talk sessions such that each team has an associated push-to-talk session, and
wherein the game client is capable of transferring at least one of the parameters such that the network entity advertises the transferred parameters of each game session to a respective team.

12. A method of effectuating a push-to-talk service in a gaming environment, the method comprising:
interacting with a network entity in a gaming architecture to play an electronic game;
establishing a push-to-talk session in a multimedia service architecture, the push-to-talk session having at least one associated parameter; and
transferring at least one of the parameters to the network entity.

13. A method according to claim 12 further comprising:
receiving a request from the network entity to establish a push-to-talk session,
wherein establishing a push-to-talk session comprises establishing a push-to-talk session in response to the request.

14. A method according to claim 12, wherein establishing a push-to-talk session includes receiving at least one associated parameter, and wherein at least one of the parameters comprises a session address.

15. A method according to claim 12, wherein interacting with a network entity comprises interacting with a network entity during a game session, and
wherein transferring at least one of the parameters comprises transferring at least one of the parameters such that the network entity advertises the transferred parameters to at least one client in the same game session.

16. A method according to claim 12, wherein interacting with a network entity comprises interacting with a network entity to play an electronic game being played by a plurality of teams each having at least one client,
wherein establishing a push-to-talk session comprises establishing a plurality of push-to-talk sessions such that each team has an associated push-to-talk session, and
wherein transferring at least one of the parameters comprises transferring at least one of the parameters such that the network entity advertises the transferred parameters of each game session to a respective team.

17. A computer program product for effectuating a push-to-talk service in a gaming environment, wherein the computer program product comprises at least one computer-readable storage medium having computer-readable program code portions stored therein, the computer-readable program code portions comprising:
a first executable portion for interacting with a network entity in a gaming architecture to play an electronic game;
a second executable portion for establishing a push-to-talk session in a multimedia service architecture, the push-to-talk session having at least one associated parameter; and
a third executable portion for transferring at least one of the parameters to the network entity.

18. A computer program product according to claim 17 further comprising:
a fourth executable portion for receiving a request from the network entity to establish a push-to-talk session,
wherein the second executable portion is adapted to establish the push-to-talk session in response to the request.

19. A computer program product according to claim 17, wherein the second executable portion is adapted to receive at least one associated parameter during establishment of the push-to-talk sesssion, and wherein at least one of the parameters comprises a session address.

20. A computer program product according to claim 17, wherein the first executable portion is adapted to interact with a network entity during a game session, and
wherein the third executable portion is adapted to transfer at least one of the parameters such that the network entity advertises the transferred parameters to at least one client in the same game session.

21. A computer program product according to claim 17, wherein the first executable portion is adapted to interact with a network entity to play an electronic game being played by a plurality of teams each having at least one client,
wherein the second executable portion is adapted to establish a plurality of push-to-talk sessions such that each team has an associated push-to-talk session, and
wherein the third executable portion is adapted to transfer at least one of the parameters such that the network entity advertises the transferred parameters of each game session to a respective team.

22. A network entity for facilitating a push-to-talk service in a gaming environment, the network entity comprising:
a processor capable of at least partially operating an electronic game in a gaming architecture, the electronic game being playable by at least one client,
wherein the processor is capable of receiving at least one parameter of a push-to-talk session in a multimedia service architecture, the push-to-talk session having been established by a client interacting with the processor to play the electronic game, and
wherein the processor is capable of advertising the parameters to at least one client to thereby enable the clients to join the push-to-talk session based upon the parameters.
